(19) United States
(12) Patent Application Publication
(10) Pub. No.: US 2010/0288917 A1
(43) Pub. Date: Nov. 18, 2010

(54) System and method for analyzing contents of sample based on quality of mass spectra

(75) Inventors: Javier E. Satulovsky, Santa Clara, CA (US); Gregor Overney, San Jose, CA (US)

Correspondence Address: Agilent Technologies, Inc. in care of:;CPA Global, P. O. Box 52050, Minneapolis, MN, 55402, US

(73) Assignee: AGILENT TECHNOLOGIES, INC., Loveland, CO (US)

(21) Appl. No.: 12/465,001

(22) Filed: May 13, 2009

(51) Int. Cl. H01J 49/26

(52) U.S. Cl. 250/282; 250/281

(57) ABSTRACT

A method of performing tandem mass spectrometry (MS/MS) for identifying contents of a sample includes performing a mass spectrometry (MS) scan of the sample to obtain an MS/MS mass spectrum; identifying a first precursor ion species in the MS mass spectrum; performing an initial MS/MS scan of the first precursor ion species to obtain an initial MS/MS mass spectrum; and determining whether the initial MS/MS mass spectrum has a quality acceptable for peptide sequencing. When the first MS/MS mass spectrum has an unacceptable quality, the method further includes performing a subsequent MS/MS scan of the first precursor ion species to obtain a corresponding subsequent MS/MS mass spectrum of the first precursor ion species, and determining whether the subsequent MS/MS mass spectrum has a quality acceptable for peptide sequencing.

### BACKGROUND

Generally, mass spectrometers measure or mass-to-charge ratios of ions obtained from samples, enabling contents of the samples to be identified. Use of mass spectrometers has been expanded to include identification of proteins and corresponding peptides. This requires ions of a protein in the sample to be volatilized, in accordance with a variety of volatilizing techniques, such as electrospray ionization (ESI) and matrix-assisted laser desorption and ionization (MALDI), and provided to a mass analyzer of the mass spectrometer. The proteins and peptides may then be identified, for example, by matching the mass-to-charge ratios at which peaks occur in the mass spectrum to a database of mass-to-charge ratios of known proteins and peptides.

Tandem mass spectrometry (MS/MS) and liquid chromatography (LC)-MS/MS, for example, provide multi-stage measurements of a sample, for example, using separate analyzers corresponding to the multiple stages, or using a single analyzer to analyze the sample multiple times. Currently, powerful computer processing and enhanced performance of bioinformatics tools that analyze mass spectrometry data make it possible to match MS/MS scan results to a peptide from a sample in real-time. That is, the peptide may be identified between two successive scans of a mass spectrometer (i.e., the time it takes to acquire one mass spectrum).

Protein mass fingerprinting is a common technique used to characterize biological samples. A biological sample is proteolytically digested, and the resulting peptides are chromatographically separated and the results of the separation are analyzed by MS/MS. In a typical setting, a quadrupole time-of-flight (Q-TOF) mass spectrometer or an ion trap mass spectrometer is used to perform the analysis. For example, the peptides in the sample are ionized by ESI to produce precursor ions, which are filtered by mass and fragmented by collision induced dissociation (CID) to produce a characteristic MS/MS mass spectrum. By matching the experimental MS/MS mass spectrum to theoretical mass spectra of known peptides and corresponding proteins in a database, e.g., generated by computer simulation, the peptides and, hence, the proteins in the sample can be identified.

However, MS/MS analysis for protein fingerprinting typically uses less than 50 percent of the acquired mass spectra. This is because the quality of the remaining, unused mass spectra is not sufficient for current software tools to analyze due to low quality or ambiguous presentation. Further, while the nature of CID constrains the fragmentation pathway of an ion as a function of its sequence, parameters affecting peptide fragmentation, such as collision energy voltage, etc., are only configured as a function of the charge and mass of the peptide.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a functional block diagram illustrating a system for tandem mass spectrometry acquisition, according to a representative embodiment.

FIG. 2 is a flow diagram of a method for tandem mass spectrometry acquisition, according to a representative embodiment.

FIG. 3 is a schematic diagram showing tandem mass spectrometry acquisition, according to a representative embodiment.

FIG. 4 is a functional block diagram illustrating a system for tandem mass spectrometry acquisition, according to a representative embodiment.

### DETAILED DESCRIPTION

In the following detailed description, for purposes of explanation and not limitation, illustrative embodiments disclosing specific details are set forth in order to provide a thorough understanding of embodiments according to the present teachings. However, it will be apparent to one having had the benefit of the present disclosure that other embodiments according to the present teachings that depart from the specific details disclosed herein remain within the scope of the appended claims. Moreover, descriptions of well-known devices and methods may be omitted so as not to obscure the description of the example embodiments. Such methods and devices are within the scope of the present teachings.

In various embodiments, an MS/MS system performs a single MS scan of a sample to generate an MS mass spectrum having peaks corresponding to precursor ion species, each of which includes multiple precursor ions of that precursor ion species. An MS/MS scan is performed on selected precursor ion species, to improve the chances of identifying the primary sequence of each of the precursor ion species. In other words, results-dependent decisions are made in response to the MS scan to obtain highest quality MS/MS mass spectra.

Generally, according to various embodiments, when an initial MS/MS mass spectrum of acquired peptides of a biological sample, e.g., in a protein fingerprinting process, is low quality, the corresponding precursor ion species is subject to a subsequent MS/MS scan in a real-time data-dependent manner. In other words, the subsequent MS/MS scan of the precursor ion species is performed using either the same acquisition parameters or changing at least one acquisition parameter, depending on the nature of the initial low quality MS/MS mass spectrum. The acquisition parameters that may be changed include acquisition time (i.e., the length of the MS/MS scan) and various fragmentation parameters, such as collision cell voltage and/or collision drag voltage. MS/MS scans of the precursor ion species may be repeated multiple times, if necessary, until a sufficiently high quality MS/MS mass spectrum is obtained of that of precursor ion species.

By re-scanning in real-time each precursor ion species having a low quality MS/MS mass spectrum, which would otherwise have little value for successful peptide-to-spectrum matches, the percentage of acquired high quality mass spectra that the tandem mass spectrometer generates and the number of peptide identifications increases. Higher peptide identifications result in higher protein coverage and better characterization of the biological sample. Real-time adjustment of the acquisition parameters may be based, in part, on previously acquired MS/MS mass spectra of the same precursor ion species.

Thus, in accordance with various embodiments, fast MS/MS scan rates enable timely and efficient acquisitions of multiple, consecutive MS/MS mass spectra of a precursor ion species when previously acquired MS/MS mass spectra are determined to be unacceptable candidates for processing, including peptide sequencing and protein identification, for example. Unlike conventional approaches, e.g., which implement decisions as lookup tables of different degrees of sophistication, the various embodiments analyze spectral quality of an MS/MS mass spectrum in order to determine whether to perform another MS/MS scan to acquire another MS/MS mass spectrum for analysis, in real-time. Also, unlike conventional lookup tables used for identifying fragmentation parameters, the various embodiments provide a flexible feedback loop, in which acquisition parameters, such as acquisition time and fragmentation parameters, are dynamically determined and adjusted, if needed, based on current progress toward being able to identify a particular peptide from a precursor ion species. This more effectively targets characteristics of the actual peptides, enables more effective use of instrument time, and the like.

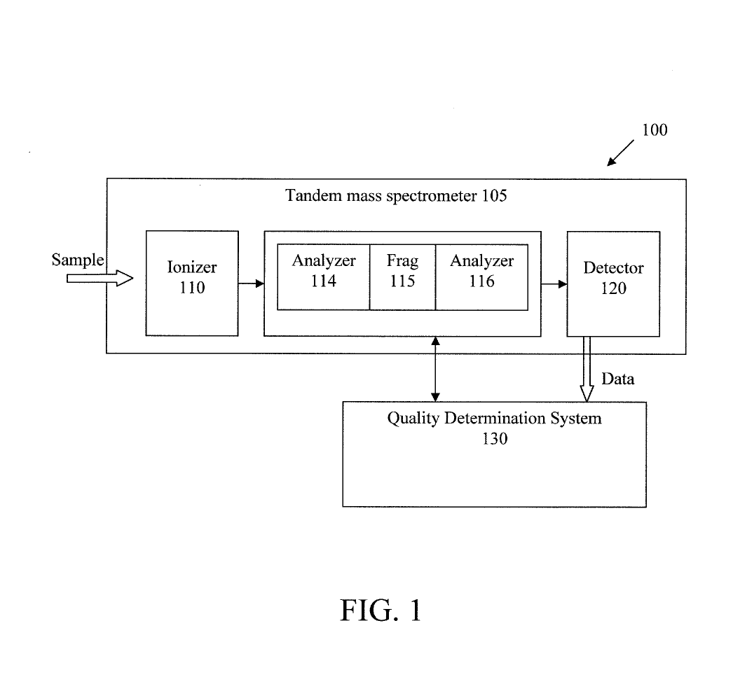

FIG. 1 is a functional block diagram illustrating a tandem mass spectrometry system 100, according to a representative embodiment. The tandem mass spectrometry system 100 may be an LC/MS/MS system, for example, which collects, measures, processes and/or analyzes various samples for identification of the molecular contents, such as peptides, amino acids, proteins and the like.

In the depicted representative embodiment, the tandem mass spectrometry system 100 includes a tandem mass spectrometer 105 and a quality determination system 130. The tandem mass spectrometer 105 includes an ionizer 110, mass analyzers 114 and 116, a fragmentation device 115 and a detector 120. The ionizer 110 receives samples that include proteins to be identified, each protein consisting of corresponding peptides. The ionizer 110 may be an ESI or MALDI source, for example, that ionizes the sample proteins to provide precursor ions to the mass analyzers 114 and 116.

During an MS/MS scan, the mass analyzer 114 selects precursor ions, the fragmentation device 115 fragments the selected precursor ions and the mass analyzer 116 sorts the fragmented precursor ions according to respective masses. Although two representative mass analyzers 114 and 116 are shown, the tandem mass spectrometer 100 may include additional mass analyzers. The fragmentation device 115 may be a collision cell or an electron transfer dissociation device, for example. The sorted ions are provided to detector 120, which measures the abundance of ions of the various masses in a mass range mass, to generate qualitative or quantitative data regarding the sample.

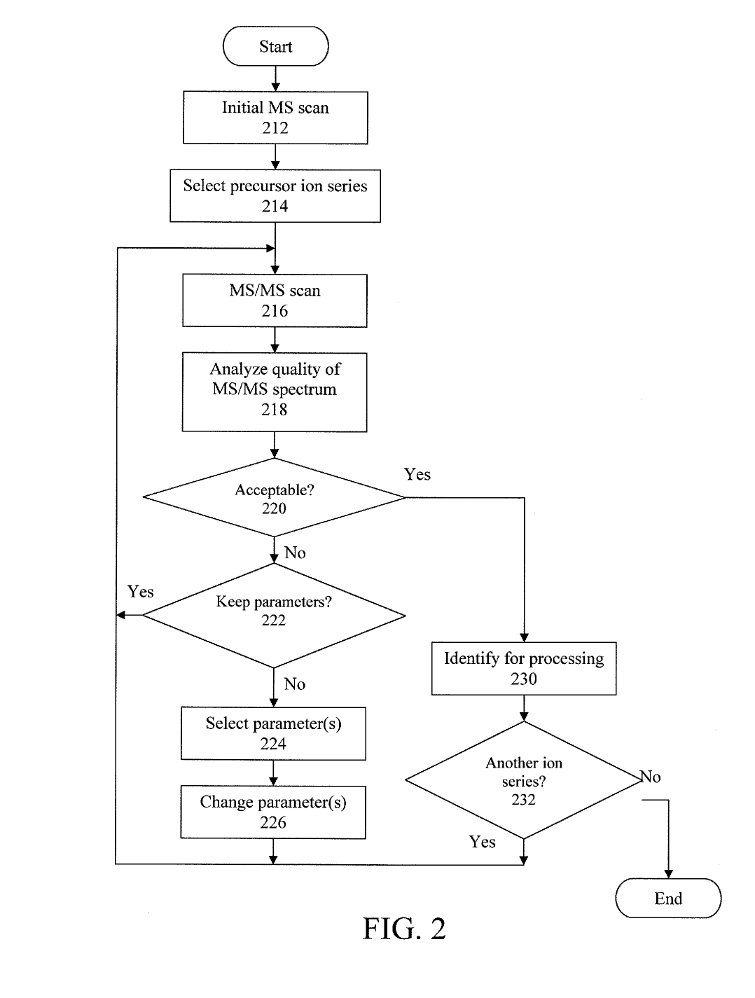

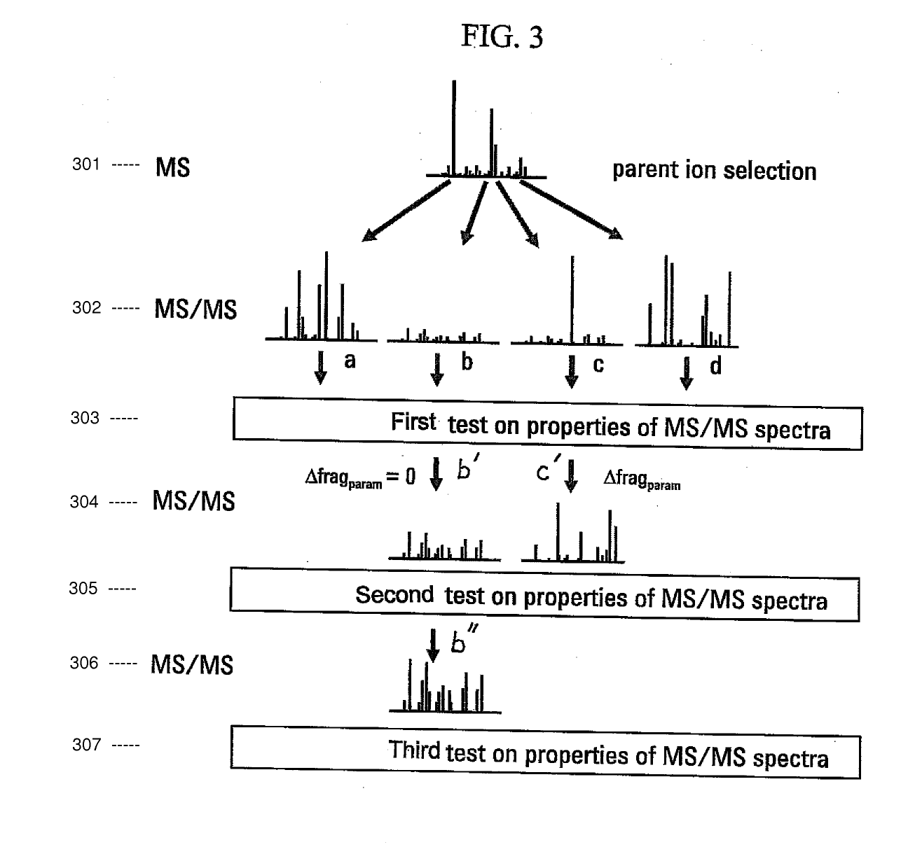

The quality determination system 130 performs various processing operations relating to the MS/MS scans, including mass spectra quality based acquisition, in accordance with various embodiments discussed below with respect to FIGS. 2 and 3. Although depicted separately, the processor 130 may be included within one or any combination of the ionizer 110, the analyzers 114 and 116, and the detector 120, in various embodiments.

FIG. 2 is a flow diagram illustrating a method of quality based MS/MS acquisition, according to a representative embodiment. FIG. 3 is a schematic diagram illustrating selection and analysis of precursor ions using quality based MS/MS acquisition, according to a representative embodiment. Various steps of FIG. 2 correlate to the stages depicted in FIG. 3, as discussed below.

Referring to FIG. 2, an initial MS scan of a biological sample is performed in block 212 to obtain a mass spectrum indicating species of precursor ions. At block 214, a number of the precursor ion species are selected, e.g., by processor 130, based on the mass spectrum, using a variety of criteria, such as mass and charge state, isotopic distribution, ion intensity profiles and/or prior decisions on whether to select a particular precursor ion during a previous MS scan. Each of the selected Precursor ion species contained in the mass spectrum of the initial MS scan (or series of initial MS scans) is subject to at least one subsequent MS/MS scan, discussed below with respect to blocks 216 through 220.

As stated above, the selection of ion species may depend on criteria including mass and charge state, isotopic distribution and/or ion intensity profiles. With respect to mass and charge state, the energy of the fragmentation device 115 changes proportionally to a mass/charge (m/z) ratio value of the precursor ion. Optimal fragmentation efficiencies have a linear relationship with the value of m/z. This approach is particularly suited for the resonant excitation process of ion traps. However, a central, data independent reference value for normalized collision energy is set for the entire sample. With respect to isotropic distribution, the isotopic distribution of each precursor ion species observed pursuant to the initial MS scan is used to determine whether that precursor ion species should be subjected to the at least one subsequent MS/MS scan. Isotopic distribution selection is typically used for targeted workflows and elimination of noise or superfluous ion species present in the initial MS mass spectra. With respect to ion intensity profiles, a subset of the most intense precursor ion species observed pursuant to the initial MS scan are selected for subsequent MS/MS scans, because more intense precursor ion species typically have better signal/noise ratios in the subsequent MS/MS scan. To this end, selection of a maximum on the chromatographic elution peaks of the precursor ion species is achieved by extracting, e.g., in real-time, the precursor ion for each precursor ion species, as described for example, by Overney et al., Real-time Analysis of Mass Spectrometry Data for Identifying Peptidic Data of Interest, U.S. Patent Application Pub. No. 2006/0243900 (Nov. 2, 2006), the contents of which are hereby incorporated by reference.

Returning to FIG. 2, at block 216, an MS/MS scan is performed for each of the selected precursor ion species. For purposes of simplifying explanation, it is assumed that the MS/MS scan is performed consecutively with respect to each of the precursor ion species until all precursor ion species selected in block 214 have been corresponding MS/MS mass spectra, which are determined to be either acceptable for analysis or rejected, as discussed below. However, it will be understood that, in alternative embodiments, the MS/MS scans indicated by block 216 may be performed simultaneously for any or all of the precursor ion species, as will be descried below with reference to FIG. 3.

The quality of the MS/MS mass spectrum, obtained by the MS/MS scan of a first selected precursor ion species, is analyzed in block 218, e.g., by processor 130. The quality of the MS/MS mass spectrum is represented using one or more of a variety of quality measures. The quality of the MS/MS mass spectrum provides an estimator of the probability that the mass spectrum can be successfully matched to a peptide from a particular database. For example, the quality of the MS/MS mass spectrum may be determined by cumulative intensity normalization of the mass spectrum in addition to the likelihood that the masses of a product ion peak pair differs by the mass of one amino acid, for example, as disclosed by Na et al., Quality Assessment of Tandem Mass Spectra Based on Cumulative Intensity Normaliation, J. PROTEOME RES., 5:3241 (December 2006), the contents of which is hereby incorporated by reference. Most quality estimators contain parameters that need to be estimated from a curated (previously analyzed) set of mass spectra. In that case, a sample of similar nature to the sample being analyzed is used for parameter estimation.

In another embodiment, the quality of the mass spectrum is determined through extraction of sequence tags from the mass spectrum and filtering a target peptide database, in real-time, using the sequence tags. The quality estimator of the mass spectrum is then defined as a function that is inversely proportional respect to the number of peptides filtered from the database.

At block 220, it is determined whether, the quality determined in block 218 is acceptable for purposes of obtaining usable data from the MS/MS mass spectrum. For example, the quality may be compared to a predetermined theoretical or empirical threshold. When the quality is acceptable (block 220: Yes), the precursor ion is identified for further processing at block 230. For example, the precursor ion may be included in a list of precursor ions corresponding to the sample. The processing may include identifying peptides from the precursor ion or otherwise obtaining data to identify the protein(s) contained in the sample. The peptide identification may be performed in real-time, for example, which may be used to increase protein coverage. The peptide identification may use a combination of de novo peptide sequencing and a filtered database search to efficiently identify the best scoring peptide sequences corresponding to the acquired MS/MS mass spectra. An example of efficient use of peptide identification, as well as use of the peptide information in the remainder of an MS/MS scan, is described in a U.S. Patent Application, by Satulovsky, entitled Method for Acquiring Data using Peptide Sequence (Docket No. 20080555-01), the contents of which is hereby incorporated by reference.

At block 232, it is determined whether additional precursor ion species are to be subjected to MS/MS scans. When there are additional precursor ion species (block 232: Yes), the process returns to block 216 to execute an MS/MS scan of another precursor ion species selected from the initial MS scan of block 212. Otherwise, the process ends (block 232: No), or is repeated, beginning at block 212, with another initial MS scan.

Referring again to block 220, when the quality of the MS/MS mass spectrum is not acceptable (block 220: No), the precursor ion species having the unacceptable MS/MS mass spectrum is selected for an additional MS/MS scan and analysis of the resulting MS/MS mass spectrum, which essentially involves repeating blocks 216 through 220. However, prior to performing the additional MS/MS scan, the process determines at block 222 whether acquisition parameters, including e.g., fragmentation parameters and/or acquisition time, used in the previous MS/MS scan at block 216 will remain the same or change. The purpose is to avoid simply repeating the same inadequate MS/MS scan and analysis of the same precursor ion species when there is no indication that the current acquisition parameters will yield different (acceptable) results.

The decision of whether to change the acquisition parameters (e.g., fragmentation parameters and/or acquisition time) may be based on factors associated with the chromatography, previously acquired MS mass spectra, any properties of one or more previously acquired MS/MS mass spectra and/or previous attempts to identify proteins and peptides using previously acquired mass spectra. For example, decision of whether to change the acquisition parameters may be based on results of de novo peptide sequencing algorithms, results of algorithms developed for spectrum-to-peptide matching using a database search, results of algorithms that assess spectral quality, and/or a measure of ambiguity or uncertainty as a result of trying to match the current MS/MS mass spectrum to a specific database.

When it is determined that the acquisition parameters are to remain the same (block 222: Yes), the process returns to block 216 to perform the MS/MS scan of the precursor ion species. The expectation is that, at the time of the subsequent MS/MS scan, the abundance of the precursor ion may differ sufficiently from its previous abundance to provide an adequate MS/MS mass spectrum, or alternatively, that adding the new MS/MS mass spectrum to the previous MS/MS mass spectrum will increase the signal-to-noise ratio of the signal. For example, the intensity of the subsequent MS/MS scan may increase without changing any of the original acquisition parameters. This may occur, for example, when the previous MS/MS scan was performed early or late in a chromatographic elution peak. The decision not to change the acquisition parameters may be reached, for example, based on the properties of the previous MS/MS mass spectrum alone, or from properties of a series of consecutive MS/MS mass spectra of the precursor ion species. An example of a property from a series of MS/MS mass spectra is total intensity resulting from adding all peaks of the MS/MS mass spectra.

Assuming that the acquisition parameters continue not to change, the process effectively enters a loop among blocks 216 through 222 until the MS/MS mass spectrum is acceptable or the process otherwise ends, in which case the process moves on to the next selected precursor ion species (block 216) from the initial MS scan or performs the next MS precursor ion species selection (block 212). That is, scanning and analysis of MS/MS mass spectra can be performed iteratively as many times as necessary, e.g., within chromatography time scales, and the maximum number of subsequent MS/MS scans may be dictated by various user defined criteria. For example, the precursor ion may be rejected after a predetermined maximum number of consecutive MS/MS scans have been performed or consecutive MS/MS scans have been performed for a predetermined time without producing an acceptable result. Alternatively, intermediate tests performed after each MS/MS scan, e.g., at any of the stages indicated in FIG. 3, may conclude that it is not worth trying to rescue a particular low quality mass spectrum, for example, due to of insufficient progress in consecutively performed MS/MS scans.

Referring again to block 222, when it is determined that the acquisition parameters are to change (block 222: No), the process continues to block 224, in which at least one acquisition parameter is selected to be changed. In block 226, each selected acquisition parameter is changed to a respective new value, and the process returns to block 216 for performance of a subsequent MS/MS scan using the changed acquisition parameter. For example, in a Q-TOF using CID, fragmentation parameters may be changed, such as collision cell voltage and/or collision drag voltage. Other types of instruments may involve changing various other acquisition parameters. A practical consideration of changing fragmentation parameters, in particular, is whether the selected fragmentation parameters may be changed within a time compatible with the time available between executions of two consecutive MS/MS scans. The assumption in this situation is that values of the fragmentation parameters used in the previous MS/MS scan are suboptimal for fragmentation of the precursor ion species in question, and thus should be changed to enhance the probability of obtaining a high quality MS/MS mass spectrum in the next iteration.

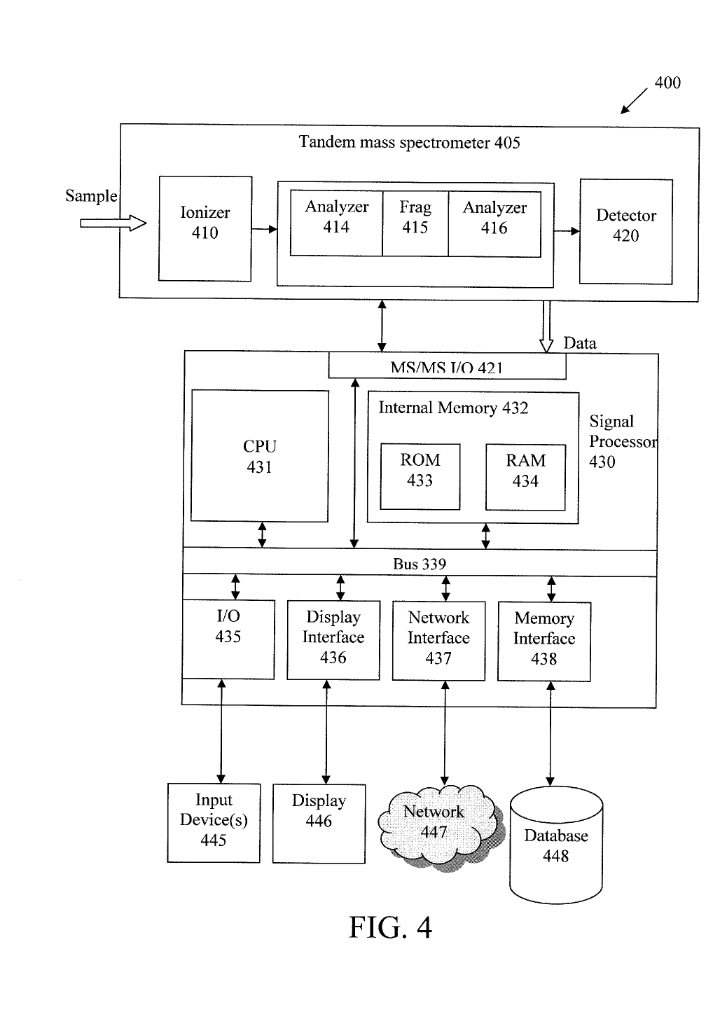

In an embodiment, new fragmentation parameter values are selected with the help of a lookup table (e.g., stored in internal memory 432 of FIG. 4, discussed below). The lookup table includes entries such as precursor ion mass, charge, isotopic distribution and/or properties of the distribution of intensities of m/z values of previously acquired MS/MS mass spectra of the precursor ion species. The lookup table may be populated using a variety of techniques, such as theoretical considerations of ion fragmentation or empirical rules based on hardware specific response. The empirical rules may be derived, for example, from machine learning approaches or other suitable methods of inference.

After the selected acquisition parameters (e.g., fragmentation parameter(s) and/or acquisition time) have been changed at block 226, the process returns to block 216 for the next MS/MS scan. Blocks 218 through 226 are then repeated until the quality of the MS/MS mass spectrum is determined to be acceptable (block 220: Yes), in which case the precursor ion species is indentified for further processing at block 230 or the precursor ion species is ultimately rejected. Of course, in subsequent passes, it may be determined to change the same or other acquisition parameters, or to keep the current acquisition parameters (as discussed above), at block 222. The process effectively enters a loop among blocks 216 through 226 until the resulting MS/MS mass spectrum is acceptable or the process otherwise ends, in which case the process moves on to the next selected precursor ion (block 216) from the initial MS scan or performs the next precursor ion species selection (block 212). That is, additional MS/MS scans and analyses of resulting MS/MS mass spectra can be performed iteratively as many times as necessary, e.g., within chromatography time scales, and the maximum number of re-scanning operations may be dictated by various user defined criteria. For example, the precursor ion species may be rejected after a predetermined maximum number of consecutive MS/MS scans or within a predetermined time period. Alternatively, intermediate tests performed after each MS/MS scan, e.g., at any of the stages indicated in FIG. 3, may conclude that it is not worth trying to rescue a particular precursor ion species having a corresponding low quality mass spectrum, for example, due to of insufficient progress in consecutively performed MS/MS scans.

Acquiring and analyzing additional MS/MS mass spectra of a precursor ion species in real-time increases the number of analyzable precursor ion species and, ultimately, corresponding peptide and protein identifications, for example. Also, given a precursor ion species, real-time assessment of the quality of its best MS/MS mass spectrum may be used to determine a temporal exclusion window used for further MS/MS scans of that precursor ion species.

FIG. 3 is a schematic diagram showing multiple stages, indicating parallel processing of precursor ion species, according to a representative embodiment. The MS and MS/MS scans and corresponding first through third tests are executed, for example, under control of quality determination system 130 of FIG. 1.

In stage 301 of FIG. 3, an initial MS scan of a sample is performed in order to select precursor ion species based on a mass spectrum from the initial MS scan, as discussed above with reference to blocks 212 and 214 of FIG. 2. In the example shown in FIG. 3, four precursor ions are selected, based on four corresponding peaks identified in the MS mass spectrum obtained by the initial MS scan.

In stage 302, an MS/MS scan is performed on each of the four selected precursor ion species, as discussed with respect to block 216 of FIG. 2, providing four respective MS/MS mass spectra, indicated as MS/MS mass spectra a, b, c and d. The MS/MS mass spectra a, b, c and d obtained in stage 302 are analyzed in accordance with a first test in stage 303, as discussed with respect to blocks 218 and 220 of FIG. 2. The first test may be based on the properties of the respective MS/MS mass spectra and/or any number of measures of quality. Examples of measures of quality include estimators based on cumulative intensity normalization or the likelihood that the masses of a pair of peaks in the mass spectrum differs by the mass of an amino-acid. In the depicted example, MS/MS mass spectra a and d are tagged as acceptable quality mass spectra and MS/MS mass spectra b and c are tagged as unacceptable quality mass spectra. MS/MS mass spectra b and c are therefore selected for additional MS/MS scans at stage 304, discussed below.

Also in accordance with the first test at stage 303, MS/MS mass spectrum b is further tagged, e.g., according to the distribution of its peaks, as a candidate for an additional MS/MS scan without changes to any acquisition parameters, as discussed with respect to block 222 of FIG. 2. In the example depicted in FIG. 3, the determination to keep the acquisition parameters the same is indicated by “Δfrag=0,” meaning that the fragmentation parameters, in particular, do not change, although it is assumed that the acquisition time likewise does not change. For example, MS/MS mass spectrum b indicates low intensities typically due to the corresponding precursor ion being selected at the beginning (or the end) of a chromatographic peak, as discussed above. MS/MS mass spectrum c, however, is tagged for an additional MS/MS scan using different fragmentation parameters, since the properties of MS/MS mass spectrum c indicate inefficient fragmentation or over-fragmentation of the corresponding precursor ion. The fragmentation parameters may be changed for subsequent MS/MS scan(s), as discussed with respect to blocks 224 through 226 of FIG. 2. Again, it is assumed that the acquisition time for the subsequent MS/MS scan of the precursor ion species indicated by MS/MS mass spectrum c does not change.

In stage 304, second MS/MS scan is performed for the two precursor ion species corresponding to MS/MS mass spectra b and c, as discussed with respect to block 216 of FIG. 2, providing two respective MS/MS mass spectra indicated as MS/MS mass spectra b′ and c′ in FIG. 3. The MS/MS mass spectra b′ and c′ obtained in stage 304 are analyzed in accordance with a second test in stage 305. In an embodiment, the second test is the same as the first test, although it will be understood that the first and second tests may differ in various embodiments.

Based on the properties of the newly acquired mass spectrum, MS/MS mass spectrum c′ is tagged as having acceptable quality, and no further MS/MS scan is performed. However, MS/MS mass spectrum b′ is tagged as having unacceptable quality. However, based on a comparison of the MS/MS mass spectrum b and the newly acquired MS/MS mass spectrum b′, it is determined that there is an increase in the quality of the MS/MS mass spectrum b′ over the MS/MS mass spectrum b. The MS/MS mass spectrum b′ is therefore again tagged for another additional MS/MS scan without changes to acquisition parameters. In an embodiment, the cumulative properties of both MS/MS mass spectra b and b′ are compared to the MS/MS mass spectrum b to determine if there is an increase in the quality of the combined MS/MS mass spectra over the MS/MS mass spectrum b.

When the quality of MS/MS mass spectrum b′ is been tagged as acceptable, or when the MS/MS mass spectrum b′ shows no improvement over the MS/MS mass spectrum b, no further MS/MS scan is necessary. Alternatively, when the MS/MS mass spectrum b′ shows no improvement over the MS/MS mass spectrum b, the MS/MS mass spectrum b′ may be tagged for an additional MS/MS scan using different acquisition parameters.

In stage 306, a third MS/MS scan is performed on the precursor ion species corresponding to MS/MS mass spectra b and b′, as discussed with respect to block 216 of FIG. 2, providing MS/MS mass spectrum b″. The MS/MS mass spectrum b″ obtained in stage 306 is analyzed in accordance with a third test in stage 307, which may be the same as or different from one or both of the first and second tests performed in stages 303 and 305, respectively. Based on the properties of the newly acquired mass spectrum, MS/MS mass spectrum b″ is tagged as having acceptable quality in the depicted example, and no further MS/MS scan is performed. As discussed above, in an alternative embodiment, the cumulative properties of the MS/MS mass spectra b, b′ and b″ are analyzed to determine whether the combined MS/MS mass spectra are acceptable. Although three stages of MS/MS scans and subsequent tests are shown in FIG. 3, it will be understood that the number of stages and tests is not limited, but rather may vary to provide unique benefits for any particular situation or to meet application specific requirements of various implementations.

Any fragmentation parameter affecting the mean-free path of ions in the collision cell or the CID process itself may be used altered in subsequent MS/MS scans. Such parameters include, but are not limited to, collision energy voltage and collision cell drag voltage. In FIGS. 2 and 3, it is assumed that fragmentation is performed by CID, although the processes are applicable to any other form of fragmentation, including but not limited to electron transfer dissociation, electron capture dissociation, for example. When fragmentation techniques other than CID are used, any fragmentation parameter affecting the fragmentation pathway of the precursor peptides may be changed with the purpose of improving the quality of subsequent MS/MS scans. In addition, although discussed in the context of Q-TOF analyzers, the present disclosure applies to any type of tandem mass spectrometer.

FIG. 4 is a functional block diagram illustrating a tandem mass spectrometry system 400, according to a representative embodiment. The tandem mass spectrometry system 400 may be an LC/MS/MS system, for example, which collects, measures, processes and/or analyzes various samples for identification of the molecular contents, such as peptides, amino acids, proteins and the like.

In the depicted representative embodiment, the tandem mass spectrometry system 400 includes a tandem mass spectrometer 405 and a signal processor 430. The tandem mass spectrometer 405 includes an ionizer 410, mass analyzers 414 and 416, a fragmentation device 415 and a detector 420. The ionizer 410 receives samples that include proteins to be identified, each protein consisting of corresponding peptides. The ionizer 410 may be an ESI or MALDI source, for example, that ionizes the sample proteins to provide precursor ions to the mass analyzer 414 and 416. During an MS/MS scan, the mass analyzer 414 selects precursor ions, the fragmentation device 415 fragments the selected precursor ions and the mass analyzer 416 sorts the fragmented precursor ions according to respective masses. Although two representative mass analyzers 414 and 416 are shown, the tandem mass spectrometer 400 may include additional mass analyzers. The multiple mass analyzers 414 and 416 may be the same type, such as quadrupole/quadrupole mass spectrum analyzers, or different types, such as quadrupole/time-of-flight (Q-TOF) mass spectrum analyzers, for example. The fragmentation device 415 may be a collision cell or an electron transfer dissociation device, for example. The sorted ions are provided to detector 420, which measures the abundance of ions of the various masses in a mass range mass, to generate qualitative or quantitative data regarding the sample.

The signal processor 430 performs various processing operations relating to the MS/MS scan, including data dependent scan, in accordance with various embodiments, discussed above. The signal processor 430 includes central processing unit (CPU) 431, internal memory 432, bus 439 and interfaces 435-438, and is configured to receive data from the detector 420 and to control fragmentation parameters of the analyzers 415 and 416 through MS/MS interface 421. The MS/MS interface 421 may be a universal serial bus (USB) interface, an IEEE 1394 interface, or a parallel port interface, for example. In various embodiments, the signal processor 430 also interfaces with the ionizer 410 and the mass analyzers 415 and 416, as needed, through respective interfaces (not shown). As stated above, it will be understood that, although depicted separately, the signal processor 430 may be included within one or any combination of the ionizer 410, the analyzer 415 and the detector 420, in various embodiments.

With respect to the signal processor 430, the internal memory 432 includes at least nonvolatile read only memory (ROM) 433 and volatile random access memory (RAM) 434, although it is understood that internal memory 432 may be implemented as any number, type and combination of ROM and RAM, and may provide look-up tables and/or other relational functionality. In various embodiments, the internal memory 432 may include a disk drive or flash memory, for example. Further, the internal memory 432 may store program instructions and results of calculations or summaries performed by CPU 431.

The CPU 431 is configured to execute one or more software algorithms, including the data dependent acquisition process of the embodiments described herein, in conjunction with the internal memory 432. In various embodiments, the CPU 431 may also execute software algorithms to control the basic functionality of the tandem mass spectrometry system 400. The CPU 431 may include its own memory (e.g., nonvolatile memory) for storing executable software code that allows it to perform the various functions. Alternatively, the executable code may be stored in designated memory locations within internal memory 432. The CPU 431 executes an operating system, such as a Windows® operating system available from Microsoft Corporation, a Linux operating system, a Unix operating system (e.g., Solaris™ available from Sun Microsystems, Inc.), or a NetWare® operating system available from Novell, Inc. The operating system may control execution of other programs, including collection and separation of samples, mass analysis and detection, e.g., by the ionizer 410, the mass analyzer 415 and the detector 420.

In an embodiment, a user and/or other computers may interact with the signal processor 430 using input device(s) 445 through I/O interface 435. The input device(s) 445 may include any type of input device, for example, a keyboard, a track ball, a mouse, a touch pad or touch-sensitive display, and the like. Also, information may be displayed by the signal processor 430 on display 446 through display interface 436, which may include any type of graphical user interface (GUI), for example. The displayed information includes the processing results obtained by the CPU 431 executing the method of peptide, described herein.

The processing results of the CPU 431 may also be stored in the database 448 through memory interface 438. The database 448 may include any type and combination of volatile and/or nonvolatile storage medium and corresponding interface, including hard disk, compact disc (e.g., CD-R/CD/RW), USB, flash memory, or the like. The stored processing results may be viewed, e.g., on the display 446, and/or further processed at a later time. Also, the processing results may be provided to other computer systems connected to network 447 through network interface 437. The network 447 may be any network capable of transporting electronic data, such as the Internet, a local area network (LAN), a wireless LAN, and the like. The network interface 437 may include, for example, a transceiver (not shown), including a receiver and a transmitter, that provides functionality for the tandem mass spectrometry system 400 to communicate wirelessly over the data network through an antenna system (not shown), according to appropriate standard protocols. However, it is understood that the network interface 437 may include any type of interface (wired or wireless) with the communications network, including various types of digital modems, for example.

The various “parts” shown in the signal processor 430 may be physically implemented using a software-controlled microprocessor, hard-wired logic circuits, or a combination thereof. Also, while the parts are functionally segregated in the signal processor 430 for explanation purposes, they may be combined variously in any physical implementation.

The data-dependent decisions described in this disclosure may be applied in conjunction with any targeted fingerprinting approach in which biological pathways or any prior knowledge of the sample is available. In that case, the decision to re-acquire and analyze an inadequate MS/MS mass spectrum, e.g., which is ambiguous for sequencing purposes, may be based on whether possible peptides matching that spectrum are present in the biological pathway of interest or are consistent with the prior knowledge being confirmed in the targeted approach.

While specific embodiments are disclosed herein, many variations are possible, which remain within the concept and scope of the invention. Such variations would become clear after inspection of the specification, drawings and claims herein. The invention therefore is not to be restricted except within the scope of the appended claims.

What is claimed is:

1. A system for analyzing a sample in a single measurement run, the system comprising:
tandem mass spectrometer configured initially to perform a mass spectrometry (MS) scan of the sample to provide an MS mass spectrum indicating precursor ion species, and to perform a tandem mass spectrum (MS/MS) scan of a first precursor ion species, selected from the precursor ion species indicted by the MS mass spectrum, to provide a first MS/MS mass spectrum using a first acquisition parameter; and
a processor configured to determine a quality of the first MS/MS spectrum of the first precursor ion species, and when the processor determines that the quality of the first MS/MS mass spectrum is unacceptable for content analysis, and in the single measurement run, the processor determines a second acquisition parameter, the tandem mass spectrometer using the second acquisition parameter to perform a second MS/MS scan of the first precursor ion species to obtain a second MS/MS mass spectrum.

2. The system of claim 1, wherein when the quality of the first MS/MS mass spectrum is adequate for content analysis, the processor identifies at least one peptide corresponding to a protein of the sample using the first MS/MS mass spectrum.

3. The system of claim 1, wherein, when the quality of the first MS/MS mass spectrum is inadequate for content analysis, the processor determines whether the second acquisition parameter is to be different from the first fragmentation parameter, based on the first MS/MS mass spectrum.

4. The system of claim 3, wherein the second acquisition parameter is the same as the first acquisition parameter.

5. The system of claim 3, wherein the second acquisition parameter is different from the first acquisition parameter.

6. The system of claim 3, wherein each of the first acquisition parameter and the second acquisition parameter comprises a collision cell voltage.

7. The system of claim 3, wherein each of the first acquisition parameter and the second acquisition parameter comprises a collision drag voltage.

8. The system of claim 1, wherein the processor selects the first precursor ion species based on at least one of a mass to-charge ratio of the first precursor ion species indicated by the MS mass spectrum.

9. The system of claim 1, wherein the processor selects the first precursor ion species based on an isotopic distribution of the first precursor ion species indicated by the MS mass spectrum.

10. The system of claim 1, wherein the processor selects the first precursor ion species is based on an intensity profile of the first precursor ion species indicated by the MS mass spectrum.

11. The system of claim 1, wherein the processor is further configured to determine a quality of the second MS/MS mass spectrum, and
wherein, when the processor determines that the quality of the second MS/MS mass spectrum is unacceptable for content analysis, and in the single measurement run, the processor determines a third acquisition parameter, the tandem mass spectrometer using the third acquisition parameter to perform a third MS/MS scan of the first precursor ion species to obtain a third MS/MS mass spectrum.

12. A method of performing tandem mass spectrometry (MS/MS) for identifying contents of a sample, the method comprising:
performing a mass spectrometry (MS) scan of the sample to obtain an MS/MS mass spectrum;
identifying a first precursor ion species in the MS mass spectrum;
performing an initial MS/MS scan of the first precursor ion species to obtain an initial MS/MS mass spectrum;
determining whether the initial MS/MS mass spectrum has a quality acceptable for peptide sequencing;
when the first MS/MS mass spectrum has an unacceptable quality, performing operations comprising:
performing a subsequent MS/MS scan of the first precursor ion species to obtain a subsequent MS/MS mass spectrum of the first precursor ion species;
and determining whether the subsequent MS/MS mass spectrum has a quality acceptable for peptide sequencing.

13. The method of claim 12, wherein the initial MS/MS scan is performed using an initial fragmentation parameter and the subsequent MS/MS scan of the first precursor ion is performed using a subsequent fragmentation parameter.

14. The method of claim 13, wherein the subsequent fragmentation parameter has a value that is different from the initial fragmentation parameter.

15. The method of claim 12, further comprising:
identifying a second precursor ion species in the initial MS mass spectrum;
performing an initial MS/MS scan of the second precursor ion species to obtain an initial MS/MS mass spectrum of the second precursor ion species;
determining whether the initial MS/MS mass spectrum of the second precursor ion species has a quality acceptable for peptide sequencing;
when the initial MS/MS mass spectrum of the second precursor ion species has an unacceptable quality, performing operations comprising:
performing a subsequent MS/MS scan of the second precursor ion species to obtain a corresponding subsequent MS/MS mass spectrum of the second precursor ion species; and
determining whether the subsequent MS/MS mass spectrum has a quality acceptable for peptide sequencing.

16. The method of claim 12, wherein the subsequent MS/MS scan of the first precursor ion species is performed using a fragmentation parameter that is different than an initial fragmentation parameter used in the initial MS/MS scan.

17. The method of claim 16, wherein the subsequent MS/MS scan of the second precursor ion species is performed using a fragmentation parameter that is the same as the initial fragmentation parameter.

18. A computer readable medium that stores a program, executable by a processor, for enabling content analysis of a sample, the computer readable medium comprising:
a selecting code segment for selecting a first precursor ion species for content analysis based on a mass spectrometry (MS) mass spectrum obtained by MS scan of the sample;
a quality determining code segment for determining a quality of a first tandem mass spectrometry (MS/MS) spectrum obtained by a first MS/MS scan of the selected first precursor ion species; and
a parameter determining code segment for determining a fragmentation parameter, for use in a second MS/MS scan of the selected first precursor ion species, when the determined quality of the first MS/MS mass spectrum is unacceptable, the second MS/MS scan of the selected first precursor ion species being performed using the determined fragmentation parameter to obtain a second MS/MS mass spectrum.

19. The computer readable medium of claim 18, wherein the determined fragmentation parameter for use in the second MS/MS scan of the selected first precursor ion species is the same as a fragmentation parameter used in the first MS/MS scan of the selected first precursor ion species.

20. The computer readable medium of claim 18, wherein the determined fragmentation parameter for use in the second MS/MS scan of the selected first precursor ion species is different from a fragmentation parameter used in the first MS/MS scan of the selected first precursor ion species.
